(19) United States
(12) Patent Application Publication
(10) Pub. No.: US 2016/0124965 A1
(43) Pub. Date: May 5, 2016

(54) Biased Users Detection

(71) Applicant: International Business Machines Corporation, ARMONK, NY (US)

(72) Inventors: Jian Dong Ding, Shanghai (CN); Min Gong, Shanghai (CN); Yu Wang, Beijing (CN); Junchi Yan, Shanghai (CN); Chao Zhang, Beijing (CN); Ya Nan Zhang, SHANGHAI (CN)

(21) Appl. No.: 14/886,426

(22) Filed: Oct. 19, 2015

(30) Foreign Application Priority Data
Oct. 30, 2014 (CN) 201410599092.X

(51) Int. Cl. G06F 17/30; H04L 12/58; H04L 29/08

(52) U.S. Cl. CPC G06F 17/3053; H04L 67/10; H04L 51/32; H04L 51/16; G06F 17/30867; G06F 17/30528

(57) ABSTRACT

Biased users detection. The present invention includes a computer implemented method for detecting biased users and a corresponding apparatus, the computer implemented method including: obtaining comments on a given topic by standard users and users to be detected; calculating respectively scores in attribute dimensions for the given topic by the standard users and the users to be detected according to the comments on the given topic by the standard users and the users to be detected, so as to map respectively the standard users and the users to be detected into a multi-dimensional space formed by a plurality of attribute dimensions, wherein the attribute dimensions reflect aspects of the given topic; and determining whether the users to be detected are biased users according to the similarity of distribution of the users to be detected and that of the standard users in the multi-dimensional space.

### CROSS-REFERENCE TO RELATED APPLICATION

This application claims the benefit of priority to Chinese Patent Application No. 201410599092.X, filed Oct. 30, 2014, the contents of which are incorporated herein by reference.

### BACKGROUND

The present invention relates to the field of an apparatus for detecting biased users and more particularly the present invention relates to a method for detecting biased users.

With the development of the Internet technology, social network platforms such as web portals, bulletin board system (BBS), Weibo and Weixin have become a more and more important means for people to obtain and share information and resources, and have evolved into a virtual social form. On various social network platforms, people comment on various topics (for example, a product), and the comments play an important role for thoroughly understanding and assessing various aspects of the topic. However, there are also many comments by biased users on the Internet, and these comments can deviate from the mainstream thoughts on some aspect of a topic, and thus do not consider other aspects of the topic; or the they can belong to the “Internet Water Army”, who are usually hired by someone to publish a large amount of abnormal comments to control the public opinion for a specific purpose such as marketing or unfair competition. Therefore, a problem that needs to be solved is how to get rid of the comments by biased users among the large amount of comments on the Internet to get more rational and objective user comments, so as to help to get more rational and objective understanding on a specific topic.

### SUMMARY

In one aspect of the present invention, there is provided a computer implemented method for detecting biased users, including: obtaining comments on a given topic by standard users and users to be detected; calculating respectively scores in attribute dimensions for the given topic by the standard users and the users to be detected according to the comments on the given topic by the standard users and the users to be detected, so as to map respectively the standard users and the users to be detected into a multi-dimensional space formed by a plurality of attribute dimensions, wherein the attribute dimensions reflect aspects of the given topic; and determining whether the users to be detected are biased users according to the similarity of distribution of the users to be detected and that of the standard users in the multi-dimensional space.

In another aspect of the present invention, there is provided an apparatus for detecting biased users, including: a memory; a processor communicatively coupled to the memory; and an obtaining module, a score calculating module, and a determining module communicatively coupled to the memory and the processor, wherein: the obtaining module is configured to obtain comments on a given topic by standard users and users to be detected; the score calculating module is configured to calculate scores in attribute dimensions for the given topic by the standard users and the users to be detected according to the comments on the given topic by the standard users and the users to be detected, so as to map respectively the standard users and the users to be detected into a multi-dimensional space formed by a plurality of attribute dimensions, wherein the attribute dimensions reflect aspects of the given topic; and the determining module is configured to determine whether the users to be detected are biased users according to the similarity of distribution of the users to be detected and that of the standard users in the multi-dimensional space.

The technical solution of the present invention can effectively detect and identify biased users and their comments among user comments on the Internet, so as to help to get more rational and objective comments on a specific topic excluding the biased comments.

### BRIEF DESCRIPTION OF THE SEVERAL VIEWS OF THE DRAWINGS

The above and other objects, features and advantages of the present invention will become more apparent through the more detailed description of embodiments of the present invention below to be read in conjunction with the accompanying drawings, in which the same reference generally refers to the same components in the embodiments of the present invention.

FIG. 1 shows a method for detecting biased users according to an embodiment of the present invention;

FIG. 2 schematically shows the principle of the method for detecting biased users according to an embodiment of the present invention;

FIG. 3 shows an apparatus for detecting biased users according to an embodiment of the present invention; and

FIG. 4 shows an exemplary computer system 12 which is applicable to implement the embodiments of the present invention.

### DETAILED DESCRIPTION

Some preferred embodiments will be described in more detail below with reference to the accompanying drawings, in which the preferred embodiments of the present disclosure are illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

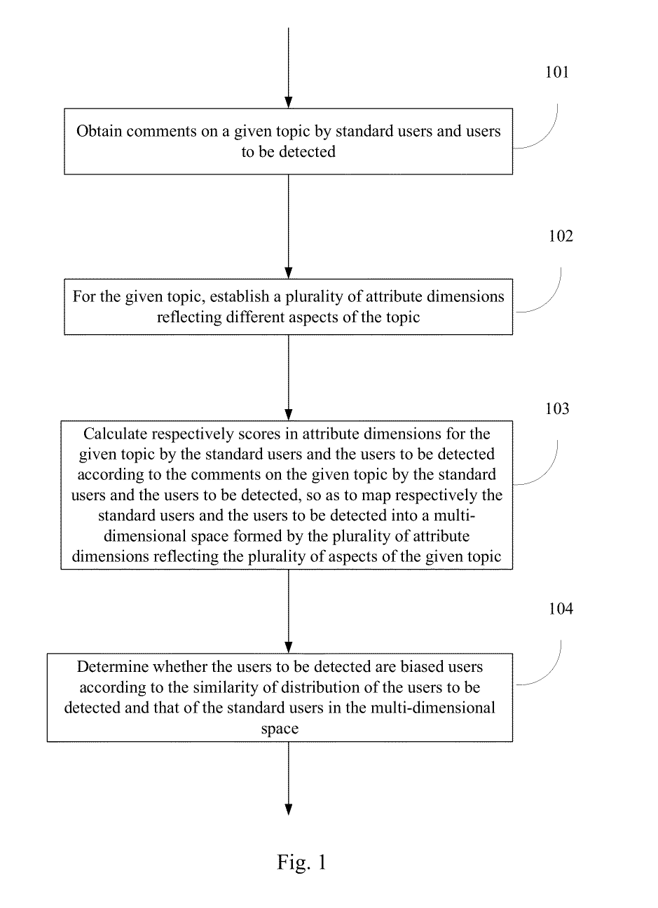

Now referring to FIG. 1, it shows a method for detecting biased users according to one aspect of the present invention. As shown, the method includes the following steps:

In step 101, standard user comments and user comments to be detected on a given topic are obtained. The given topic can be some category of products, e.g., cars, or can be any other topics of interest to people. The standard user comments and the user comments to be detected can both be from the Internet, e.g., web portals, BBSs, Weibo, Weixin, etc.

The standard user comments can be normal user comments which have been proven to exclude abnormal comments by the “Internet Water Army”. The standard user comments can come from history data of user comments on the given topic, e.g., user comment data from websites where a real-name registration system is implemented, comment data in specialist forums which are widely recognized, or comment data of users which have higher levels and get wide approval in BBS, etc.

The standard user comments and the user comments to be detected are both associated with users, and they both have user IDs. The user ID can be a user ID registered on a website by the user, the IP address of the user's Internet browsing equipment, etc. One user ID can correspond to one or more comments. Therefore, the standard user comments and the user comments to be detected can be divided into different user IDs. The obtained standard user comments can be stored in a standard user comment database.

In step 102, for a given topic, a plurality of attribute dimensions reflecting different aspects of the topic are established. For example, for the topic of cars, attribute dimensions of miniature, low-price etc. can be established. Thus, the attribute dimensions can form a multi-dimensional space.

In step 103, according to one or more comments of each user ID in the standard user comments, scores in the various attribute dimensions for the given topic by the user are calculated; and similarly, for each user ID to which the user comments to be detected belong, scores in the respective attribute dimensions for the given topic by the user are calculated according to the user ID's one or more comments to be detected.

In this way, a score matrix is obtained, of which each column can represent a user ID, each row can represent an attribute dimension, and each matrix element can represent the score in the attribute dimension represented by the row by the user ID represented by the column.

One of the current scoring methods can be used to calculate the score of a user ID's comment in an attribute dimension, e.g., the following process can be used to calculate the score of a user ID's comment in an attribute dimension:

In step 1031, a comment word database is created, and the comment words can include “excellent”, “extremely good”, “good”, “not bad”, “bad”, etc. The comment words can be created by users of the apparatus of the present invention according to their experience, experts' opinions and history data of user comments, or can be created automatically by the apparatus of the present invention according to history data of user comments.

In sub-step 1032, for each comment word in the comment word database, a score is assigned to the comment word according to whether the user's attitude reflected by the comment word is positive or negative, as well as its intensity. For example, “extremely good” can be given the highest score, “good” a bit lower score, “not bad” a still lower score, and “bad” the lowest score. This step can be executed by users of the apparatus of the present invention according to their experiences or expert opinions.

In sub-step 1033, for each comment of a user ID, first it is determined to which attribute dimension of the given topic the comment relates, and then comment word segmentation is performed on the comment, so as to get one or more comment words forming the comment.

In step 1034, different weights are given to the comment words forming the comment, so as to normalize the final score of the comment (e.g., between 0 and 1). This step can be performed by users of the apparatus of the present invention according to their experiences or expert opinions.

In sub-step 1035, the scores of all the comment words of the comment are multiplied by their respective weights, so as to get the score by the user ID to which the comment belongs in the topic dimension involved in the comment. The score can be, e.g., between 0 and 1, and the higher the score, the higher the evaluation. In this way, the score in each attribute dimension of a given topic by each user ID is obtained, and thus a score matrix is obtained.

For the missing elements in the score matrix, i.e., the specific user ID cannot have any comments for specific attributes, a current matrix filling technology can be used to fill them. The matrix filling technology can be, for example, the collaborative filtering usually used for a recommendation system, the matrix decomposition algorithm, etc.

Thus, a user ID can be represented by one point in the multi-dimensional attribute space formed by the attribute dimensions, and the coordinate values of the point denote the score data set for each attribute dimension by the user ID. That is to say, the standard users and the users to be detected can be mapped into the multi-dimensional attribute space, and be represented by some points in the multi-dimensional attribute space.

Returning to FIG. 1, in step 104, it is determined whether the users to be detected are biased users according to the similarity of distribution of the users to be detected and that the standard users in the multi-dimensional attribute space. That is to say, if the user to be detected in the multi-dimensional attribute space is close to the standard users' distribution, it can be determined that the users to be detected are not biased users; and if the users be detected are far away from the standard users' distribution in the multi-dimensional attribute space, they can be determined to be biased users.

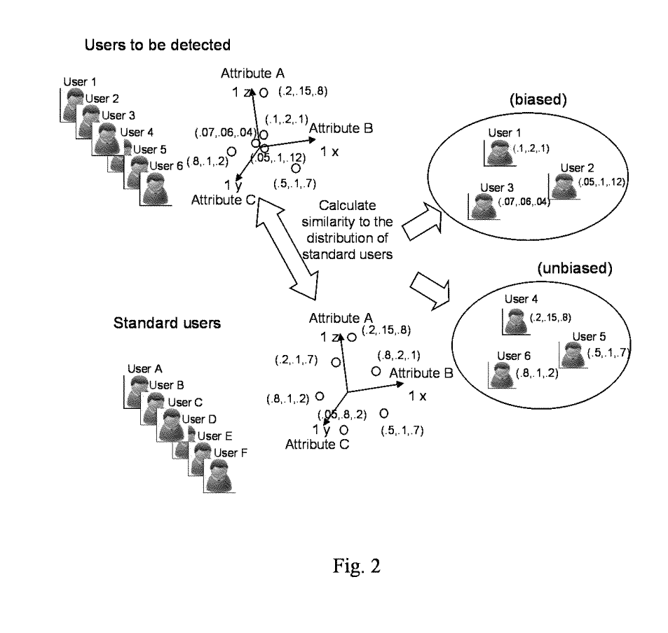

FIG. 2 schematically shows the principle of the method for detecting the biased users according to one aspect of the present invention. As shown in FIG. 2, according to the scores for the three attribute dimensions, attribute A, attribute B, and attribute C, of a specific topic by the users' comments, users 1 to 6 to be detected and the standard users A to F are all mapped to the three-dimensional space formed by attribute A, attribute B and attribute C. The standard user A to F have specific distribution regions in the three-dimensional space. User 4, 5 and 6 to be detected are close to the distribution regions of the standard users, and thus it can be determined that user 4, user 5 and user 6 to be detected are non-biased users. However, user 1, 2, and 3 to be detected are far away from the distribution regions of the standard users and are concentrated around the origin, and thus it is determined that user 1, user 2 and user 3 to be detected are biased users.

There are many methods to detect the similarity of distribution of the users to be detected and that of the standard users in the multi-dimensional space. For example, the similarity of distribution of the users to be detected and that the standard users can be determined by using the similarity determination method based on classification hyperplane. According to some embodiments of the present invention, the similarity of distribution of users to be detected and that of the standard users in the multi-dimensional space is determined in the following process:

In sub-step 1041, all the points denoting the standard users and all the points denoting the users to be detected in the multi-dimensional space are clustered, so that all the standard users are clustered into some clusters, e.g., into three clusters A, B and C, and all the users to be detected are also clustered into some clusters, e.g., cluster 1, 2, and 3. The physical meaning of clustering users lies in that, different users can focus on different attribute dimensions. For example, some users focus on the appearance of products, and thus are inclined to give a higher score to a specific appearance attribute; some users focus on cost performance ratio, and thus are inclined to give a higher score to a lower-price attribute; and some users focus on brands, and thus are inclined to give a higher or lower score to a specific brand, etc.

One of the existing clustering methods can be used to perform the clustering. For example, the methods of K-average value, grid-based clustering, etc. can be used to perform the clustering. Then, the cluster center of each cluster can be calculated.

In sub-step 1042, in the multi-dimensional attribute space, for each cluster of users to be detected, the distance from its cluster center to the cluster center of each cluster of standard users is calculated.

In sub-step 1043, in response to the calculated distance from the cluster center of a cluster of users to be detected to the cluster center of each cluster of standard users is greater than the specified threshold, it is determined that the cluster of users to be detected is a cluster of biased users.

On the other hand, if the distance from the cluster center of the cluster of users to be detected to the cluster center of a cluster of standard users is smaller than or equal to the specified threshold, it is determined that the cluster of users to be detected belongs to the cluster of standard users, thus not belonging to the cluster of biased users.

For example, for cluster 1 of users to be detected, the distances from its cluster center to the cluster centers of clusters A, B and C of standard users are calculated respectively as Dis(1, A), Dis(1, B), Dis(1, C). If Dis(1, A), Dis(1, B), Dis(1, C) are all greater than a specified threshold, it can be determined that cluster 1 of users to be detected can be a cluster of biased users.

Further, the probability that the users to be detected are biased users can be calculated according to one or more of the distances. For example, the greater the distance is, the greater the probability of the biased users is.

After that, the determined non-biased users and biased users can be processed accordingly. For example, the comments of the non-biased users can be incorporated into a comment set, to get relatively objective and effective comments on the given topic, and to exclude comments of the biased users. For further example, the comments of the determined non-biased users can be stored into a standard user comment database, to be used for future detection of biased user comments, etc. In addition, for the determined biased users, their behaviors can be further analyzed by the users of the apparatus of the present invention according to their experiences or expert opinions, to be further confirmed or processed in other ways.

Above is described a method for detecting biased users according to one aspect of the present invention by referring to the accompanying drawings. It should be pointed out that the above description is merely exemplary, rather than restriction to the present invention. In other embodiments of the present invention, the method can have more, less or different steps, and the relationships of sequence, inclusion, function etc. between the steps can be different from that is described and illustrated.

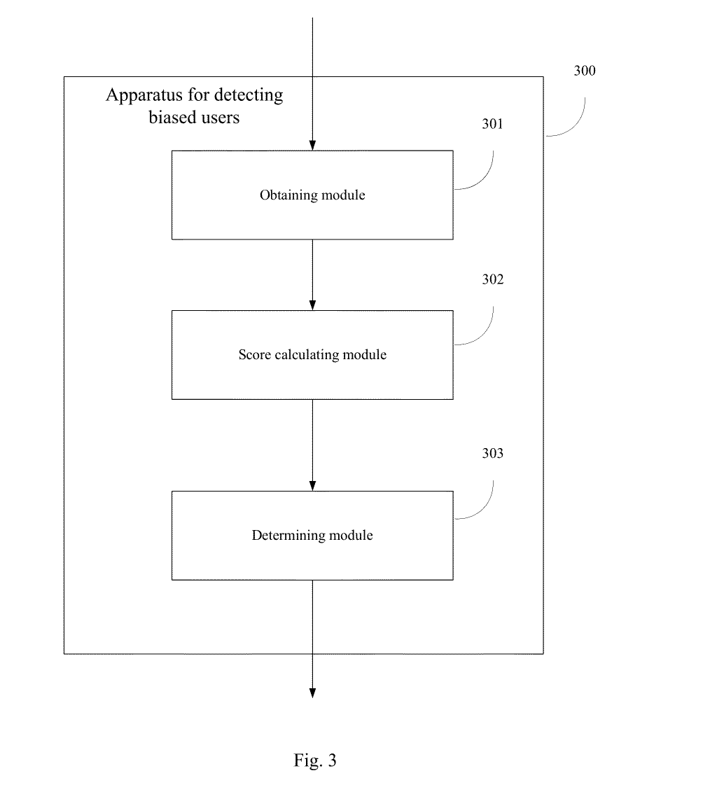

Now referring to FIG. 3, it describes an apparatus for detecting the biased users according to one aspect of the present invention. The modules in the apparatus can be used to execute the above corresponding steps of the method according to one aspect of the present invention. For simplicity, some details repetitive with the above description are omitted in the following description. Therefore, more detailed understanding of the apparatus can be obtained by referring to the above description.

As shown in FIG. 3, apparatus 300 includes the following modules: a memory; a processor communicatively coupled to the memory; and an obtaining module, a score calculating module and a determining module communicatively couples to the memory and the processor, wherein: an obtaining module 301 configured to obtain the comments on a given topic by the standard users and users to be detected; a score calculating module 302 configured to calculate the scores in attribute dimensions for the given topic by the standard users and the users to be detected respectively according to the comments on the given topic by the standard users and the users to be detected, so as to map the standard users and the users to be detected into a multi-dimensional space formed by a plurality of attribute dimensions, wherein the attribute dimensions reflect aspects of the given topic; and a determining module 303 configured to detect whether the users to be detected are biased users according to the similarity of the users to be detected and that of the standard users distributed in the multi-dimensional space.

According to one aspect of the present invention, the determining module 303 includes the following sub-modules: a clustering sub-module configured to cluster the standard users and the users to be detected in the multi-dimensional space; a distance calculating sub-module configured to, for each cluster of users to be detected, calculate the distance from its cluster center to the cluster center of each cluster of standard users; and a determining sub-module configured to, in response to the calculated distance from the cluster center of a cluster of users to be detected to the cluster center of each cluster of standard users being greater than a specified threshold, determine that the cluster of users to be detected is a cluster of biased users.

According to one aspect of the present invention, the determining sub-module is further configured to: in response to the calculated distance from the cluster center of a cluster of users to be detected to the cluster center of a cluster of standard users being smaller than the specified threshold, determine that the cluster of users to be detected belongs to the cluster of standard users.

According to one aspect of the present invention, the score calculating module 302 includes: a database establishing sub-module configured to establish a comment word database, and assign scores to the comment words in the database; an attribute dimension determining sub-module configured to determine the attribute dimension of the given topic involved in the user comment; a segmenting sub-module configured to perform comment word segmentation on a user comment, so as to obtain one or more comment words forming the comment; a weighting sub-module configured to assign weights to the one or more comment words forming the comment; a score obtaining sub-module configured to multiply the scores of one or more comment words belonging to the same attribute dimension by their weights and then add them up, so as to get a score in the attribute dimension for the given topic by the user comment.

According to one aspect of the present invention, the score calculating module 302 further includes: a matrix forming sub-module configured to form a matrix, of which each column representing a user, each row representing an attribute dimension, and each element representing a score in the corresponding attribute dimension for the given topic by the corresponding user; a matrix filling sub-module configured to, for the missing elements in the matrix, fill them by using the matrix filling method.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

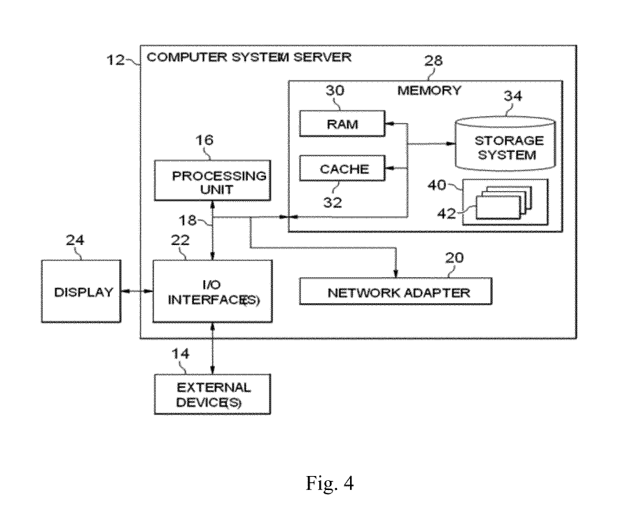

Referring now to FIG. 4, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 4, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components can be used in conjunction with computer system/server 12. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A computer implemented method for detecting biased users, comprising:
obtaining comments on a given topic by standard users and users to be detected;
calculating respectively scores in attribute dimensions for the given topic by the standard users and the users to be detected according to the comments on the given topic by the standard users and the users to be detected, so as to map respectively the standard users and the users to be detected into a multi-dimensional space formed by a plurality of attribute dimensions, wherein the attribute dimensions reflect aspects of the given topic; and
determining whether the users to be detected are biased users according to the similarity of distribution of the users to be detected and that of the standard users in the multi-dimensional space.

2. The computer implemented method of claim 1, wherein the determining step comprises:
clustering the standard users and the users to be detected respectively in the multi-dimensional space;
for each cluster of users to be detected, calculating the distance from its cluster center to the cluster center of each cluster of standard users; and
determining that a cluster of users to be detected belongs to a cluster of biased users in response to the calculated distance from the cluster center of a cluster of users to be detected to the cluster center of each cluster of standard users being greater than a specified threshold.

3. The computer implemented method of claim 2, further comprising:
in response to the calculated distance from the cluster center of a cluster of users to be detected to the cluster center of a cluster of standard users being smaller than the specified threshold, determining that the cluster of users to be detected belongs to the cluster of standard users.

4. The computer implemented method of claim 1, wherein the calculating step comprises:
establishing a comment word database, and assigning scores to the comment words in the database;
determining the attribute dimensions of the given topic involved in the user comments;
performing comment word segmentation on a user comment, so as to obtain one or more comment words forming the comment;
assigning weights to the one or more comment words forming the comment; and
multiplying the scores of the one or more comment words belonging to the same attribute dimension by their weights and then adding them up, so as to get a score in the attribute dimension for the given topic by the user comment.

5. The computer implemented method of claim 4, wherein the calculating step further comprises:
forming a matrix of which each column represents a user, each row represents an attribute dimension, and each element represents a score in the corresponding attribute dimension for the given topic by the corresponding user; and
filling the missing elements in the matrix using a matrix filling method.

6. An apparatus for detecting biased users comprising:
a memory;
a processor communicatively coupled to the memory; and
an obtaining module, a score calculating module and a determining module communicatively coupled to the memory and the processor, wherein:
the obtaining module is configured to obtain comments on a given topic by standard users and users to be detected;
the score calculating module is configured to calculate respectively scores in attribute dimensions for the given topic by the standard users and the users to be detected according to the comments on the given topic by the standard users and the users to be detected, so as to map respectively the standard users and the users to be detected into a multi-dimensional space formed by a plurality of attribute dimensions, wherein the attribute dimensions reflect aspects of the given topic; and
the determining module is configured to determine whether the users to be detected are biased users according to the similarity of distribution of the users to be detected and that of the standard users in the multi-dimensional space.

7. The apparatus of claim 6, wherein the determining module comprises:
a clustering sub-module configured to cluster the standard users and the users to be detected respectively in the multi-dimensional space;
a distance calculating sub-module configured to, for each cluster of users to be detected, calculate the distance from its cluster center to the cluster center of each cluster of standard users; and
a determining sub-module configured to, in response to the calculated distance from the cluster center of a cluster of users to be detected to the cluster center of each cluster of standard users being greater than a specified threshold, determine that the cluster of users to be detected belongs to a cluster of biased users.

8. The apparatus of claim 7, wherein the determining sub-module is further configured to:
in response to the calculated distance from the cluster center of a cluster of users to be detected to the cluster center of a cluster of standard users being smaller than the specified threshold, determine that the cluster of users to be detected belongs to the cluster of standard users.

9. The apparatus of claim 6, wherein the score calculating module comprises:
a database establishing sub-module configured to establish a comment word database, and assign scores to the comment words in the database;
an attribute dimension determining module configured to determine the attribute dimensions of the given topic involved in the user comments;
a segmenting sub-module configured to perform comment word segmentation on a user comment, so as to obtain one or more comment words forming the comment;
a weighting sub-module configured to assign weights to the one or more comment words forming the comment; and
a score obtaining sub-module configured to multiply the scores of the one or more comment words belonging to the same attribute dimension by their weights and then add them up, so as to get a score in the attribute dimension for the given topic by the user comment.

10. The apparatus of claim 9, wherein the score calculating module further comprises:
a matrix forming sub-module configured to form a matrix, of which each column representing a user, each row representing an attribute dimension, and each element representing a score in the corresponding attribute dimensions for the given topic by the corresponding user;
a matrix filling sub-module configured to, for the missing elements in the matrix, fill them by using a matrix filling method.
